(19) United States
(12) Patent Application Publication
(10) Pub. No.: US 2008/0223168 A1
(43) Pub. Date: Sep. 18, 2008

(54) Steering Column Arrangement for a Motor Vehicle

(75) Inventors: Martin Garzke, Jena (DE); Hans Kluemper, Voegelsen (DE); Hanno Lox, Elmshorn (DE); Rainer Wilken, Alveslohe (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/589,697

(22) PCT Filed: Feb. 11, 2005
(86) PCT No.: PCT/EP2005/001388

§ 371 Date: May 20, 2008

(30) Foreign Application Priority Data
Feb. 17, 2004 (DE) 10 2004 007 554.9

(51) Int. Cl. G05G 11/00

(52) U.S. Cl. 74/484 R

(57) ABSTRACT

A steering column arrangement has a steering column tube unit which is fastened to a vehicle body via a bracket and can be adjusted for comfort purposes. The bracket has two limbs. The steering column tube unit is arranged with a clamping apparatus between the two limbs. In order to adjust the clamping apparatus simply, the limbs are configured with different rigidities.

### BACKGROUND AND SUMMARY OF THE INVENTION

This invention relates to a steering column arrangement.

German document DE 101 61 849 A1 discloses a steering column arrangement for a motor vehicle having a bracket, via which an adjustable steering column tube unit is fastened to a vehicle body. A clamping apparatus is provided, via which the steering column tube unit is connected to a limb of the bracket. The steering column tube unit known from this document is mounted on the bracket only on one side.

European document EP 0 802 104 A1 likewise discloses a steering column arrangement for a motor vehicle having an adjustable steering column tube unit which is fastened to a vehicle body via a bracket. In contrast to the steering column arrangement described above, this bracket has two limbs. The steering column tube unit is arranged with a clamping apparatus between the two limbs. This known bracket with the limbs is of symmetrical construction, with the result that the two limbs have identical rigidities.

The present invention has as an object the object of providing a steering column arrangement with a clamping apparatus which permits simple adjustment.

According to the invention, this object is achieved by a steering column arrangement having the features claimed.

The present invention is distinguished by the fact that one limb of the bracket is configured with greater flexural rigidity than the other limb of the bracket. That limb of the bracket which is less flexurally rigid yields in the direction of the steering column tube unit when the steering column tube unit is clamped. This feature facilitates the release and the clamping of the clamping apparatus, with the result that a vehicle occupant has to expend less force for this. Accordingly, the adjustment of the steering column arrangement is made considerably easier by the solution according to the invention.

Advantageous refinements are to be gathered from other claimed features.

According to one embodiment, the bracket with the limbs has a frame and stiffening ribs which are assigned to the frame. In components which are made from metal and/or plastic, stiffening ribs are used a simple measure to achieve sufficient rigidity. For example, high overall rigidity of the component can be achieved by optimum orientation of the stiffening ribs. High overall rigidity leads to a high resonant frequency which affords advantages with regards to the excitation of oscillations. As a result, the comfort can be increased for vehicle occupants.

According to a further embodiment, the bracket is of asymmetrical configuration. In particular, it is conceivable to configure the bracket asymmetrically in the region of the limbs. This is a simple possibility for achieving different rigidities for different regions as a result of different geometrical designs of the bracket. A further possibility for configuring different rigidities consists in the use of different materials.

According to a further embodiment, in the region of the limbs, the stiffening ribs of the bracket are arranged parallel to and/or perpendicularly with respect to the limbs of the bracket.

According to a further embodiment, the stiffening ribs are arranged closer to one another in the region of one limb than in the region of the other limb. The rigidity of the stiffening ribs can be influenced in a simple manner, in particular in the foot region of said stiffening ribs, by the number and the density of the arrangement of the stiffening ribs, but also by their thickness.

In order to achieve sufficient rigidity of the limbs, the limb extends over a certain length of the bracket. Here, the limb can have two regions. One region serves to bear the clamping apparatus, and the other region serves to support the limb.

According to a further embodiment, reinforcements are provided in the supporting region of the limb. The rigidity of the limbs can be set via the reinforcements. Here, the reinforcements can be configured in such a way that they ensure a high resonant frequency of the overall bracket and, secondly, the two limbs can be configured with different rigidities.

According to a further embodiment, each limb has a smaller width in its supporting region than in its bearing region.

According to a further embodiment, one limb has a recess in its supporting region. The amount of rigidity reduction can be set in a particularly simple manner via the dimensions of the recesses.

According to a further embodiment, a slot is made in the bearing region of each limb. This slot can serve to accommodate fastening elements, for example for the clamping apparatus. The embodiment described has the advantage that the slot makes it possible to adjust the steering column tube unit relative to the bracket. It is also conceivable to introduce other recesses into the limbs, such as round recesses.

In the following, the invention will be explained in greater detail using an exemplary embodiment which is shown in the drawings.

### BRIEF DESCRIPTION OF THE DRAWINGS

FIG. 1 shows a perspective view of a steering column bracket according to the invention, obliquely from below; and

FIG. 2 shows a perspective view of the steering column bracket shown in FIG. 1, but from below.

### DETAILED DESCRIPTION OF THE INVENTION

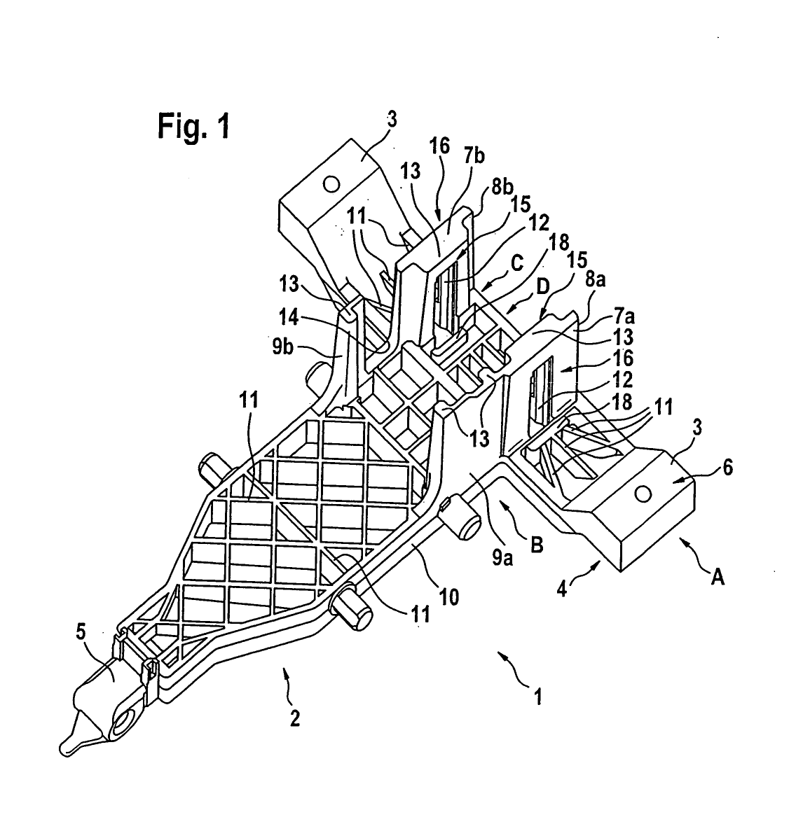

FIG. 1 shows a steering column bracket 1 which comprises a basic body 2 and two fastening elements 3 which are arranged laterally on one of its ends. The steering column bracket 1 which is of T-shaped configuration is configured to be substantially symmetrical with respect to its longitudinal axis. The steering column bracket 1 is fixed with its upper side 4 on a body part (not shown here) of a motor vehicle via the fastening elements 3 and a bearing point 5 which is situated on that end of the basic body 2 which lies opposite the fastening elements 3. At the level of the fastening elements 3, the lower side 6 of the basic body 2 has two limbs 7a, 7b which are arranged perpendicularly with respect to the basic body 2 and spaced apart from one another. The two limbs 7a, 7b extend parallel to one another and have in each case an inner side 15 and an outer side 16. If the respective inner sides 15 of the limbs 7a, 7b are mentioned in conjunction with the invention, those side faces of the limbs 7a, 7b which face one another are meant. Accordingly, the outer sides 16 of the limbs 7a, 7b are meant to be those side faces of the limbs 7a, 7b which face away from one another. The outer sides 16 of the limbs 7a, 7b terminate in each case flushly with a frame 10 of the basic body 2 which forms its outer contour. The limbs 7a, 7b are divided into a bearing region 8a, 8b and a supporting region 9a, 9b. The bearing regions 8a, 8b of the limbs 7a, 7b are arranged at the level of the fastening elements 3. The supporting regions 9a, 9b adjoin the respective bearing regions 8a, 8b of the limbs 7a, 7b. The bearing regions 8a, 8b of the limbs 7a, 7b have a greater width than the supporting regions 9a, 9b of the limbs 7a, 7b. Overall, the two limbs 7a, 7b extend over approximately one third of the length of the basic body 2.

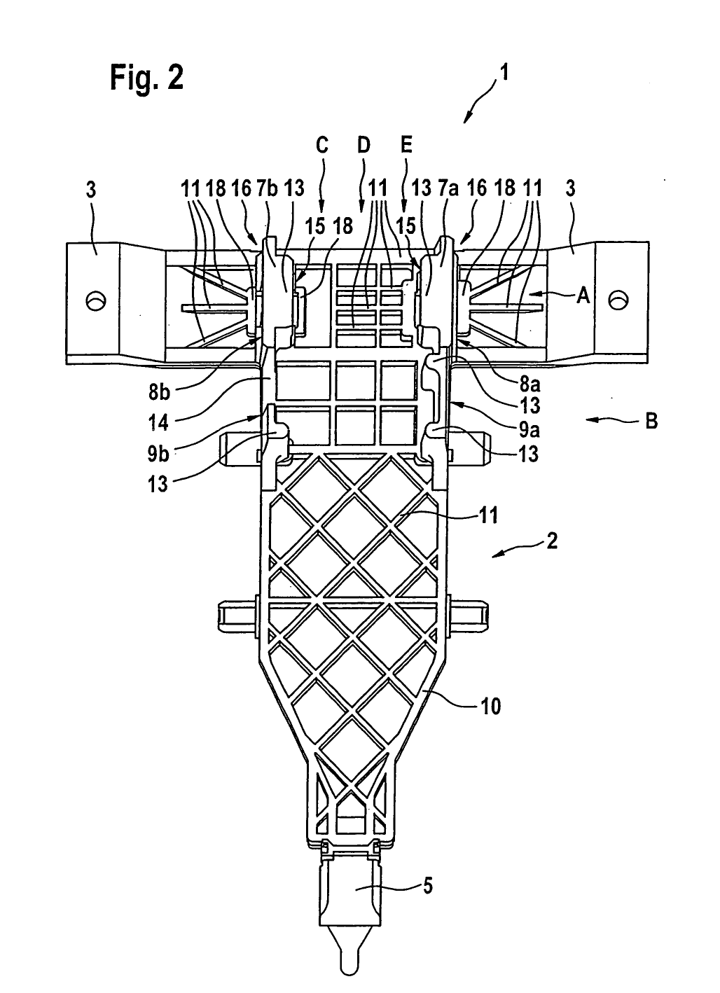

The basic body 2 is reinforced by means of stiffening ribs 11. The stiffening ribs 11 of the basic body 2 extend within the frame 10 of the basic body 2 between the two limbs 7a, 7b, both parallel to and also perpendicularly with respect to the limbs 7a, 7b, and are explained in greater detail in conjunction with FIG. 2. The remaining stiffening ribs 11 of the basic body 2 extend obliquely at an angle of 45° with respect to the limbs 7a, 7b. The fastening elements 3 likewise have stiffening ribs 11 in the region of the limbs 7a, 7b. Said stiffening ribs 11 are arranged symmetrically with respect to the respective longitudinal axis of the fastening elements 3 and run toward the respective centers of the bearing regions 8a, 8b of the limbs 7a, 7b. The stiffening ribs 11 of the fastening elements 3 run together in a connecting point. The connecting point is configured as a collecting rib 18. The thickness of this collecting rib 18 results, inter alia, from the fact that in each case one plastic part is introduced into the bracket limbs 7a, 7b, which plastic part is calked on the bracket upper side, in order to prevent it from falling out. A sufficient material thickness of the collecting rib 18 is a precondition for reliable calking.

A steering column tube (not shown) is fixed between the inner sides 15 of the two limbs 7a, 7b in a customary manner, as known from the prior art. The steering column tube is fixed via an interaction of lamellar assemblies which are fastened on the side of the bracket and lamellar assemblies which are fastened on the side of the steering column tube and a clamping bolt which penetrates the steering column tube, the limbs 7a, 7b and the lamellar assemblies. To this end, a slot 12 which extends with its longitudinal axis perpendicularly with respect to the basic body 2 is formed in each case in the bearing region 8 of the limbs 7a, 7b. The inner sides 15 of the limbs 7a, 7b have reinforcements 13 around the slot 12.

Further reinforcements 13 which extend on the inner sides 15 of the limbs 7a, 7b and perpendicularly with respect to the basic body 2 are arranged in the supporting regions 9a, 9b of the limbs 7a, 7b. In the limb 7a which is depicted on the right in FIG. 1, the reinforcements 13 are arranged on the end which faces the bearing region 8a and on that end of the supporting region 9a of the limb 7a which faces away from the bearing region 8a. The limb 7a which lies opposite this limb 7b has only one reinforcement 13 on that end of the limb 7b which faces away from the bearing region 8b. A required overall rigidity of the steering column arrangement is achieved by said reinforcements 13, which overall rigidity leads to a high resonant frequency level of the steering column oscillations.

In addition, the limb 7b which is arranged on the left in FIG. 1 has a U-shaped recess 14 in its supporting region 9b. As a result, a reduced rigidity is achieved in comparison with the other limb 7a. The recess 14 extends almost over the entire length and depth of the supporting region 9b of the limb 7b.

The asymmetrical arrangement of the stiffening ribs 11 of the basic body 2 in the foot region of the limbs 7a, 7b is apparent from FIG. 2. The stiffening ribs 11 which are arranged parallel to the limbs 7a, 7b between the two limbs 7a, 7b have a greater spacing from one another in the region of the limb 7b which is arranged on the left in FIG. 2 than in the region of the right-hand limb 7a. The stiffening ribs 11 of the basic body 2 which are arranged in the force direction perpendicularly with respect to the limbs 7a, 7b have a smaller spacing from one another at the level of the bearing regions 8a, 8b of the limbs 7a, 7b than at the level of the supporting regions 9a, 9b of the limbs 7a, 7b. In addition, no stiffening ribs 11 which extend perpendicularly with respect to the limb 7b are arranged in the region of the left-hand limb 7b at the level of the bearing region 8b. The rigidity of the steering column bracket can be adapted individually to the individual function carriers of the steering column bracket as a result of the specific arrangement of the stiffening ribs 11.

The basic body 2 is divided into two approximately equally large regions A, B in the region of the limbs 7a, 7b by three stiffening ribs 11 which extend perpendicularly with respect to the limbs 7a, 7b. Region A extends between the two bearing regions 8a, 8b of the limbs 7a, 7b, and region B extends between the two supporting regions 9a, 9b of the limbs 7a, 7b. The two stiffening ribs 11 which delimit the region A have a greater width than the stiffening rib 11 which is arranged between the region B and the remaining basic body 2.

Furthermore, the regions A and B are divided into the regions C, D and E by two stiffening ribs 11 which extend parallel to the limbs 7a, 7b. The region C is assigned to the left-hand limb 7b and the regions D, E are assigned to the right-hand limb 7a. The width of the regions D, E is identical, and the width of the region C is greater than the respective width of the regions D, E.

Furthermore, the regions D, E are divided in the region A by three stiffening ribs 11 which extend perpendicularly with respect to the limbs 7a, 7b. The regions which are produced as a result are equally wide apart from those which are arranged directly on the frame 10 of the basic body 2. The regions which are assigned to the frame 10 are of somewhat wider configuration in comparison.

In the remaining region of the basic body 2, the stiffening ribs 11 extend diagonally with respect to the two limbs 7a, 7b, a stiffening rib 11 also being formed perpendicularly with respect to the limbs 7a, 7b in the central region of the remaining basic body 2.

In order to reduce the rigidity of the limb 7b, different measures have been realized. Firstly, in contrast to the limb 7a, the limb 7b has a U-shaped recess 14 in its supporting region and is of thin-walled design. Secondly, there is no reinforcement 13 between the supporting region 9b and the bearing region 8b of the limb 7b, and stiffening ribs 11 have also been omitted in the foot region of the limb 7b. Furthermore, the stiffening ribs 11 which are arranged on the outer sides of the limbs 7a, 7b are configured with different heights. The height of these stiffening ribs 11 which are assigned to the left-hand limb 7b is lower than the height of the stiffening ribs 11 which are assigned to the right-hand limb 7a. The surface of the stiffening ribs 11 which are assigned to the right-hand limb 7a and the surface of the outer edge of the fastening element 3 terminate flushly, while the surface of the stiffening ribs 11 which are assigned to the right-hand limb 7b ends somewhat below the surface of the outer edge of the fastening element 3.

The reduced rigidity of the limb 7b makes it possible to adjust the height and length of the steering column arrangement simply, as the two limbs 7a, 7b can move relative to one another and it is easy to produce play between them when the steering column arrangement is adjusted. The driver has to apply less force for adjusting the steering column.

Both the overall rigidity of the steering column bracket and the resonant frequency level of the steering column oscillations are increased by the reinforcements 13 of the limbs 7a, 7b which are arranged in a targeted manner and by the solid configuration of the limb 7a. This leads to greater comfort for the driver, as unpleasant oscillations are reduced.

The partially contradictory requirements are met in an optimum manner by a consistent division of tasks between individual function carriers of the bracket.

1-12. (canceled)

13. A steering column arrangement for a motor vehicle, comprising:
a steering column tube unit,
a bracket by which the steering column tube unit is fastened to a vehicle body and can be adjusted for comfort purposes, the bracket having two limbs, and
a clamping apparatus with which the steering column tube unit is arranged between the two limbs,
wherein the limbs are configured with different rigidities.

14. The steering column arrangement as claimed in claim 13, wherein the bracket has a frame and stiffening ribs which are assigned to the frame.

15. The steering column arrangement as claimed in claim 13, wherein the bracket is of asymmetrical configuration.

16. The steering column arrangement as claimed in claim 13, wherein the bracket is of asymmetrical configuration in a region of the limbs.

17. The steering column arrangement as claimed in claim 16, wherein, in the region of the limbs, stiffening ribs of the bracket extend parallel to, perpendicularly with respect to, or both parallel to and perpendicularly with respect to the limbs.

18. The steering column arrangement as claimed in claim 14, wherein the stiffening ribs are at a smaller spacing from one another in the region of one limb than in the region of the other limb.

19. The steering column arrangement as claimed in claim 13, wherein each limb has both a supporting region and a bearing region.

20. The steering column arrangement as claimed in claim 19, wherein reinforcements are provided in the supporting region of the limb.

21. The steering column arrangement as claimed in claim 19, wherein each limb has a smaller width in its supporting region than in its bearing region.

22. The steering column arrangement as claimed in claim 19, wherein one limb has a recess in its supporting region.

23. The steering column arrangement as claimed in claim 19, wherein a slot is formed in the bearing region of each limb.

24. The steering column arrangement as claimed in claim 23, wherein the slot serves to accommodate a fastening element.

25. The steering column arrangement as claimed in claim 14, wherein the bracket is of asymmetrical configuration.

26. The steering column arrangement as claimed in claim 14, wherein the bracket is of asymmetrical configuration in a region of the limbs.

27. The steering column arrangement as claimed in claim 15, wherein the bracket is of asymmetrical configuration in a region of the limbs.

28. The steering column arrangement as claimed in claim 14, wherein each limb has both a supporting region and a bearing region.

29. The steering column arrangement as claimed in claim 15, wherein each limb has both a supporting region and a bearing region.

30. The steering column arrangement as claimed in claim 16, wherein each limb has both a supporting region and a bearing region.

31. The steering column arrangement as claimed in claim 17, wherein each limb has both a supporting region and a bearing region.

32. The steering column arrangement as claimed in claim 18, wherein each limb has both a supporting region and a bearing region.
